(19) United States
(12) Patent Application Publication
(10) Pub. No.: US 2017/0276612 A1
(43) Pub. Date: Sep. 28, 2017

(54) GEMSTONE VERIFICATION

(71) Applicant: SAHAJANAND TECHNOLOGIES PVT. LTD., SURAT (IN)

(72) Inventors: RAHUL MAHENDRA GAYWALA, SURAT (IN); MUNJALKUMAR DHIRAJLAL GAJJAR, SURAT (IN); CHETAN FULCHANDBHAI PATEL, SURAT (IN)

(21) Appl. No.: 15/313,562

(22) PCT Filed: Dec. 8, 2015
(86) PCT No.: PCT/IN2015/050193

§ 371 Date: Nov. 23, 2016

(30) Foreign Application Priority Data
Dec. 9, 2014 (IN) 3946/MUM/2014

(51) Int. Cl. G01N 21/87; G06K 19/06; G06F 17/30; G01N 21/956

(52) U.S. Cl. CPC G01N 21/87; G01N 21/95607; G06K 19/06028; G06F 17/30247; G01N 2021/95615; G01N 2201/06113

(57) ABSTRACT

Method(s) and System(s) for verifying authenticity of a gemstone (108) are described. The method includes receiving identification information associated with a gemstone (108). The identification information is indicative of at least one of a model number, a part number, a date, a time, and a gemstone ID associated with the gemstone (108). Thereafter, the gemstone (108) is analyzed to obtain an image pattern corresponding to the gemstone (108), the image pattern is based on refraction and reflection of a radiation incident on the gemstone (108). Thereafter, the method includes identifying a unique image pattern corresponding to the image pattern in a database. A stored identification information corresponding to the unique image pattern is then identified. The stored identification information and the unique image pattern are stored in the database for verification of the gemstone (108).

### TECHNICAL FIELD

The present subject matter relates, in general, to verification techniques and, in particular, to a verification technique for verifying gemstones.

### BACKGROUND

Owing to enormous value of gemstones, for example, diamonds, several counterfeit gemstones are sold in market for making profits by fraudulent means. Typically, authenticity of gemstones is determined based on an authentication certificate issued by a central trusted authority, for example, a government organization. In other techniques, known optical techniques are used for determining the authenticity of gemstones. For example, a gemstone merchant may determine the authenticity of a gemstone using known optical instruments.

### BRIEF DESCRIPTION OF THE DRAWINGS

The detailed description is described with reference to the accompanying figures. In the figures, the left-most digit of a reference number identifies the figure in which the reference number first appears. The same numbers are used throughout the figures to reference the same elements. Some implementations of systems and/or methods in accordance with implementations of the present subject matter are now described, by way of example only, and with reference to the accompanying figure(s), in which:

FIG. 1 illustrates a gemstone verification system for verifying authenticity of a gemstone, in accordance with an implementation of the present subject matter.

FIG. 2 illustrates components of a computing system, in accordance with an implementation of the present subject matter.

FIG. 3 illustrates a flowchart of a method for verifying authenticity of a gemstone, in accordance with an implementation of the present subject matter.

### DETAILED DESCRIPTION

Verification of a gemstone is done to ensure authenticity of a gemstone. Conventionally, authenticity of the gemstone may be determined based on an authentication certificate issued by a central trusted authority, for example, a government organization. The authentication certificate includes details such as, weight measurement, purity and cut grade of the gemstone in a coded format. The authentication certificate is generally provided along with the gemstone to a gemstone merchant or a customer as a proof of the authenticity of the gemstone. Mostly, the gemstone merchants or the customers rely on the authentication certificate and treat the gemstone to be authentic. However, a fraudulent person may produce a counterfeit certificate and sell counterfeit gemstones to the customers. The fraudulent person may tamper the coded details or replace the gemstone with a counterfeit gemstone. On such instances, the gemstone merchants may receive counterfeit gemstones and treat the counterfeit gemstones to be authentic based on the counterfeit certificate. Further, such counterfeit gemstones may be sold to the customers.

In another scenario, a gemstone merchant may manually ascertain the authenticity of the gemstone by using known optical instruments. However, in such techniques, probability of occurrence of an error may be high. For example, if the authenticity of the diamond is ascertained in low light conditions, the authenticity of the diamond may be erroneously ascertained.

The present subject matter describes techniques related to methods and systems of verifying authenticity of a gemstone. The described techniques, in accordance with the present subject matter, provide a convenient and an efficient manner to verify authenticity of the gemstone. Further, the described techniques ensure higher accuracy in verifying the authenticity.

The present subject matter describes techniques for gemstone tracking and verification. For the purpose of gemstone tracking, a unique image pattern corresponding to a gemstone is generated. The unique image pattern is obtained when the gemstone refracts and reflects an incident radiation and the radiation after refraction falls on a screen. Thereafter, the unique image pattern is associated with an identification information. The identification information may be provided by a gemstone manufacturer and may indicate a property of the gemstone. In an example, the identification information may include a weight parameter, a cut grade, a model number, a part number, a date, a time, and a gemstone ID. The identification information may be unique to the gemstone and may be utilized by the gemstone merchant to verifying authenticity of the gemstone. After associating with the identification information, the unique image pattern and the identification information may be stored in a database for tracking and verification purpose.

Further, to verify authenticity of a tracked gemstone, the identification information of a gemstone may be received. In a scenario, the identification information may be received from a gemstone merchant. The identification information may be provided in an authentication certificate in a coded format, for instance, a barcode.

Thereafter, the gemstone may be analyzed to obtain an image pattern corresponding to the gemstone. The image pattern may be obtained when the gemstone receives radiation from an illumination device and refracts and reflects the radiation into multiple radiations. The multiple radiations may then fall on a screen and form a unique image pattern. In an example, the unique image pattern formed on the screen may be a dotted pattern. After obtaining the image pattern, the image pattern may be compared with the database to identify a unique image pattern to which the image pattern corresponds. Accordingly, a stored identification information corresponding to the unique image pattern may be identified from a database. The stored identification information and the unique image pattern may be stored in the database for verification of the gemstone.

In an implementation, the identification information so received may be compared with the stored identification information to determine a match. If there is a match between the two identification information, then the gemstone may be determined to be authentic. However, if there is no match, then the gemstone may be determined to be counterfeit.

Thus, the described techniques provide a transparent platform for providing information associated with the gemstones to the gemstone merchant and the customers for verification purpose. Further, the foregoing description provides a rapid, third party verification for the consumer and the others.

These and other advantages of the present subject matter would be described in greater detail in conjunction with the following figures. While aspects of described systems and methods for verification of gemstones can be implemented in any number of different computing systems, environments, and/or configurations, the embodiments are described in the context of the following device(s).

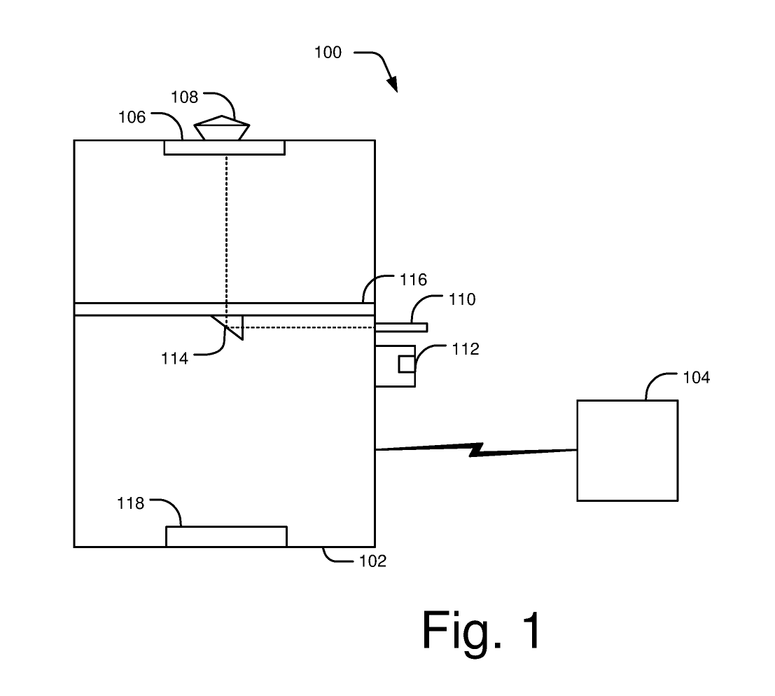

FIG. 1 illustrates a gemstone verification system 100 for verification of a gemstone 108, in accordance with an embodiment of the present subject matter.

According to an embodiment of the present subject matter, the gemstone verification system 100, hereinafter referred to as the system 100, includes an optoelectronic assembly 102, and a computing system 104. The optoelectronic assembly 102 may include a gemstone holder 106 for holding the gemstone 108, an illumination device 110, a controller 112, an optical device 114, a screen 116, and an image capturing device 118, say a camera. The optoelectronic assembly 102 may obtain a unique pattern of the gemstone 108 during operation. In an example, the gemstone 108 may be a bare gemstone, for example, a diamond.

The gemstone holder 106, in an example, may comprise two transparent glasses, say a first glass and a second glass aligned in parallel to each other. In the said example, the two glasses may reflect light or radiation onto the gemstone 108. Further, the first glass may be fixed and the second glass may be adjustable, i.e., may be moved freely along an axis.

The illumination device 110 may emit radiations that are directed towards the gemstone 108. In an implementation, the gemstone holder 106 can be so positioned with respect to the illumination device 110 that the two are linearly placed, i.e., the two are in a straight line. Further, in another implementation, the gemstone holder 106 can be so positioned with respect to the illumination device 110 that the two are non-linearly placed, i.e., the two are not in a straight line. For example, the illumination device 110 can be positioned to incident the radiations in a direction substantially perpendicular to the gemstone holder 106 holding the gemstone 108. In such a case, in an implementation, the optoelectronic assembly 102 may include the optical device 114, such as a prism, for directing the radiations from the illumination device 110 onto the gemstone 108.

In an example, operation, i.e., on and off, of the illumination device 110 may be controlled through a controller 112. The controller 112 may be connected to a computer (not shown in this figure). In one example, the illumination device 110 can be a laser source. The optical device 114 may refract the radiations from the illumination device 110 and project refracted radiation on the screen 116. In an example, the screen 116 may be drum paper fixed and may comprise one or more semi-transparent glasses (not shown in figure).

Examples of the computing system 104 may include, but are not limited to, laptop computer, a desktop computer, a notebook, a tablet, a smart phone, a workstation, a mainframe computer, a server, and the like.

In operation, the illumination device 110 may be switched on by the controller 112. The illumination device 110 may emit a radiation towards the optical device 114. In a scenario, the optical device 114 can be a prism. The optical device 114 refracts the radiation to the gemstone 108 and a unique image pattern of the gemstone 108 is formed on the screen 116. In an example, the pattern may be a dotted pattern and may be captured continually by the image capturing device 118. Thereafter, the gemstone 108 may be revolved around its axis and subsequently the pattern produced may be captured again. For example, the gemstone 108 may be rotated one hundred and eighty degrees. The unique image pattern may then be captured by image capturing device 118.

Thereafter, the computing system 104 may obtain the unique image pattern from the image capturing device 118. The computing system 104 may then associate the unique image pattern with the identification information and store in a database. For ease of reference, the identification information so stored in the database along with the unique image pattern is referred to as a stored identification information hereinafter. The stored identification information and the unique image pattern may then be utilized for tracking and verifying authenticity of the gemstone 108.

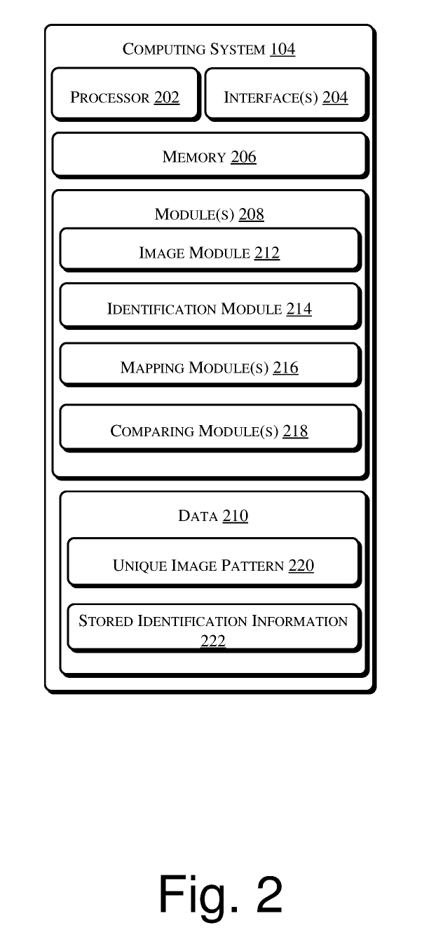

FIG. 2 illustrates components of the computing system 104 in accordance with an implementation of the present subject matter. The computing system 104 may include a processor 202, an interface 204, and a memory 206. Further, the computing system 104 may include module(s) 208 and data 210.

The processor 202, amongst other capabilities, may be configured to fetch and execute computer-readable instructions stored in the memory 206. The processor 202 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processor(s)”, may be provided through the use of dedicated hardware as well as hardware capable of executing software in association with appropriate software.

The interface(s) 204 may include a variety of machine readable instructions-based interfaces and hardware interfaces that allow the computing system 104 to interact with different entities, such as the processor 202, the module 208 and the data 210. The memory 206 may be coupled to the processor 202 and may, among other capabilities, provide data and instructions for generating different requests. The memory 206 can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The data 210 serves, amongst other things, as a repository for storing data that may be fetched, processed, received, or generated by one or more of the module(s) 208.

The module(s) 208 may perform different functionalities which may include, but may not be limited to, receiving unique image pattern from the image capturing device 118, receiving identification information corresponding to the gemstone 108, associating the identification information with the unique image pattern, and comparing a received identification information with a stored identification information to verify authenticity of the gemstone 108. Accordingly, the module(s) 208 may include an image module 212, an identification module 214, a mapping module 216, and a comparing module 218. The data 210 may include unique image pattern 220, and stored identification information 222.

In an implementation, the image module 212 may obtain the unique image pattern 220 from the image capturing device 118. Thereafter, the identification module 214 may receive identification information associated with the gemstone 108. In an example, the identification information may be provided by a gemstone manufacturer. The identification information may be understood as information indicative of property of the gemstone 108. The identification information may include a model number, a part number, a date, a time, and a gemstone ID. The gemstone ID may be generated using known methods.

In an implementation, the mapping module 216 may associate the unique image pattern with the identification information and store in the database. The unique image pattern 220 and the stored identification information is stored in the database such that the gemstone 108 may be later verified by either a gemstone merchant or a customer based on information stored in the database.

In an example, the computing system 104 may include a barcode generator (not shown in the figure) for generating a barcode based on the stored identification information. For generating the barcode, the barcode generator may obtain the stored identification information from the database and may subsequently generate the barcode. The barcode may indicate diamond dotted pattern, color, clarity and weight measurements, other parameters, and a cut grade of the gemstone. In an example, the barcode may be associated with the gemstone ID of the gemstone 108 and subsequently stored in the database by the mapping module 216. In an example, the barcode may be a two-dimensional barcode.

Additionally, the computing system 104 may be communicatively coupled to a printer (not shown in the figure) for printing the barcode and the unique image pattern 220 associated with the gemstone 108. In an example, the unique image pattern 220 and the barcode may be printed on a document, say an authentication certificate. In a scenario, the authentication certificate may be provided with the gemstone 108 to the gemstone merchant or the customer for verification of the authenticity of the gemstone.

In an example, for verifying the gemstone 108, say at a diamond merchant store by the gemstone merchant, the system 100 may receive the identification information. In a scenario, the identification information may be received in a barcode form. In such a scenario, the bar code may be scanned to obtain the corresponding identification information. In another scenario, the system 100 may receive the identification information manually from the gemstone merchant through an input device such as, a keyboard, a mouse, and a touch pad. Thereafter, the gemstone may be analysed to obtain an image pattern corresponding to the gemstone 108. During the analysis, the gemstone 108 may be placed on the gemstone holder 106 and the controller 112 may be operated to switch on the illumination device 110. The illumination device 110 may emit a radiation that may be incident on optical device 114. In a scenario, the optical device 114 may spread the radiation into multiple radiations and direct the multiple radiations towards the gemstone 108.

In an implementation, the multiple radiation may be incident on the gemstone 108. The gemstone 108 may refract and reflect each radiation from amongst the multiple radiations such that each radiation after refracting and reflecting from the gemstone 108 may fall on the screen 116. The multiple radiation may fall on the screen 116 to form an image pattern. The image capturing device 118 may then capture the image pattern formed on the screen 116. In a scenario, the image module 212 may obtain the image pattern from the image capturing device 118. The comparing module 218 may then determine if the image pattern corresponds to any unique image pattern available in the database. If the image pattern does not correspond to any unique image pattern, then the comparing module 218 may determine that the gemstone 108 is a counterfeit gemstone.

However, if the image pattern corresponds to a unique image pattern 220 stored in the database, then the mapping module 216 may identify a stored identification information such as a gemstone id, associated with the unique image pattern 220 and fetch the stored identification information 222. The comparing module 218 may then compare the stored identification information 222 with the identification information received from the gemstone manufacturer to determine a match. If there is no match, then the comparing module 218 may determine the gemstone 108 to be counterfeit. If there is a match then the gemstone 108 may be determined to be authentic.

In an implementation, the identification information may not be available or the identification information so provided is form of the bar code may be defaced. For instance, a fraudulent person may have misplaced the authentication certificate or may have tampered the bar code. In such a scenario, the optoelectronic assembly 102 may analyse the gemstone 108 to obtain an image pattern as described earlier. Thereafter, the comparing module 218 may determine if the image pattern corresponds to a unique image pattern 220 stored in the database.

If the comparing module 218 determines that the image pattern corresponds to the unique image pattern 220, then the mapping module 216 may identify the stored identification information 222 corresponding to the unique image pattern 220. The identification module 214 may then provide the stored identification information 222 to a user such as, the gemstone merchant. In a scenario, the gemstone merchant may assess the stored identification information 220 to determine authenticity of the gemstone 108. If the image pattern does not correspond to any unique image pattern 220 stored in the database, then the comparing module 218 may identify the gemstone 108 as counterfeit.

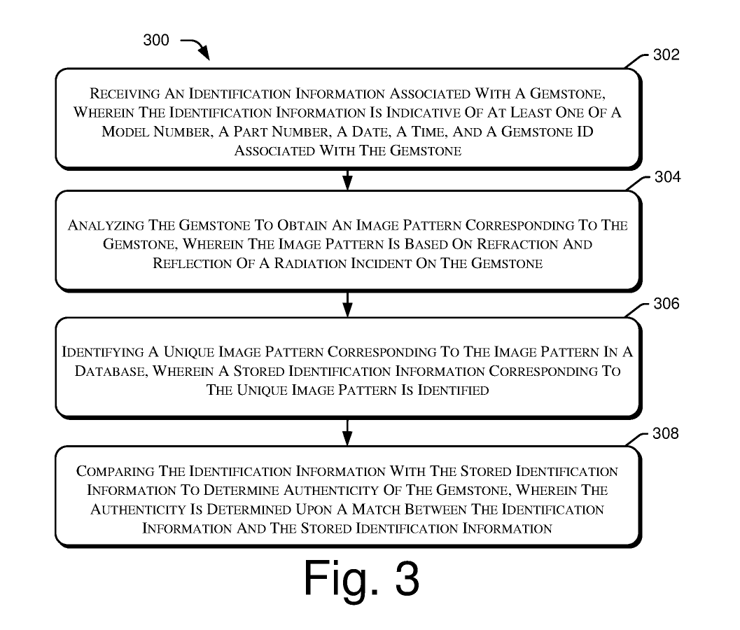

FIG. 3 illustrates a method 300 in accordance with implementations of the present subject matter. The order in which the method 300 is described is not intended to be construed as a limitation, and any number of the described method blocks may be combined in any order to implement the method 300 or an alternative method. Furthermore, the method 300 may be implemented by processor(s) or computing system(s) through any suitable hardware, non-transitory machine readable instructions, or combination thereof.

FIG. 3 illustrates a method for verifying authenticity of a gemstone 108, in accordance with an embodiment of the present subject matter. The identification information is indicative of one of a model number, a part number, a date, a time, and a gemstone ID associated with the gemstone. At block 302, identification information associated with the gemstone 108 may be received. In an implementation, the identification information may be received by the identification module 214. At block 304, the gemstone 108 may be analyzed to obtain a unique image pattern 220 corresponding to the gemstone 108. The unique image pattern 220 may be based on refraction and reflection of a radiation incident on the gemstone 108. In an implementation, the optoelectronic assembly 102 may be utilized to analyze the gemstone 108.

Thereafter, at block 304, a stored identification information 222 corresponding to the unique image pattern 220 may be identified from a database. The stored identification information 222 and the unique image pattern 220 may be stored for verification of the gemstone 108. In an implementation, the mapping module 216 may determine the stored identification information 222 corresponding to the unique image pattern 220. At block 306, the identification information may be compared with the stored identification information 222 to determine authenticity of the gemstone 108. The authenticity may be determined upon a match between the identification information and the stored identification information 222.

Thus, the described techniques provide an efficient manner of verifying authenticity of a gemstone and providing appropriate information about the identification of the gemstone to a gemstone merchant and a customer.

Although embodiments for gemstone verification as per the present subject matter have been described in a language specific to structural features and/or applications, it is to be understood that the invention is not necessarily limited to the specific features or applications described. Rather, the specific features and applications are disclosed as exemplary embodiments.

We claim:

1. A method comprising:
receiving an identification information associated with a gemstone (108), wherein the identification information is indicative of at least one of a model number, a part number, a date, a time, and a gemstone ID associated with the gemstone (108);
analyzing the gemstone (108) to obtain an image pattern corresponding to the gemstone (108), wherein the image pattern is based on refraction and reflection of a radiation incident on the gemstone (108);
identifying a unique image pattern corresponding to the image pattern in a database, wherein a stored identification information corresponding to the unique image pattern is identified, wherein the stored identification information and the unique image pattern are stored for verification of the gemstone (108);
comparing the identification information with the stored identification information to determine authenticity of the gemstone (108), wherein the authenticity is determined upon a match between the identification information and the stored identification information.

2. The method as claimed in claim 1 wherein the identification information is received in form of a bar code.

3. The method as claimed in claim 1 wherein the identification information is received from a user.

4. The method as claimed in claim 1, wherein the analyzing comprises:
emitting, by an illumination device (110), a radiation such that the radiation is incident on the gemstone (108);
forming, on a screen (116), a unique image pattern corresponding to the gemstone (108), wherein the unique image pattern is obtained in response to refraction of the radiation by the gemstone;
capturing, by an image capturing device (118), the unique image pattern formed on the screen (116).

5. The method as claimed in claim 4, wherein the unique image pattern is captured continually, and wherein the gemstone (108) is rotated by a predefined angle around an axis of rotation during the capturing.

6. A method comprising:
analyzing a gemstone (108) to obtain an image pattern corresponding to the gemstone (108), wherein the image pattern is based on refraction of a radiation incident on the gemstone (108);
identifying a unique image pattern corresponding to the image pattern in a database, wherein a stored identification information is corresponding to the unique image pattern is identified, wherein the stored identification information and the unique image pattern are stored for verification of the gemstone (108);
providing the stored identification information to a user.

7. The method as claimed in claim 6, wherein the analyzing comprises:
emitting, by an illumination device (110), a radiation such that the radiation is incident on a gemstone (108);
forming, on a screen (116), a unique image pattern corresponding to the gemstone (108), wherein the unique image pattern is obtained in response to refraction of the radiation by the gemstone;
capturing, by an image capturing device (118), the unique image pattern formed on the screen (116).

8. A gemstone verification system (100) comprising:
an optoelectronic assembly (102) to obtain a unique image pattern of a gemstone (108), wherein the optoelectronic assembly (102) comprises:
an illumination device (110) to emit a radiation to be incident on the gemstone (108);
a gemstone holder (106) to hold the gemstone (108) such that the gemstone (108):
receives the radiation emitted from the illumination device (110); and
refracts the radiation to generate the unique image pattern;
a screen (116) to form the unique image pattern corresponding to the gemstone (108); and
an image capturing device (118) to capture the unique image pattern formed on the screen (116);
a computing system (104) comprising:
a processor (120);
an image module (212) to obtain the unique image pattern from the image capturing device (118);
a mapping module (216) to associate an identification information of the gemstone (108) with the unique image pattern, wherein the identification information is indicative of at least one of a model number, a part number, a date, a time, and a gemstone ID associated with the gemstone (108); and
store the unique image pattern and the identification information in a database.

9. The gemstone verification system (100) as claimed in claim 8 further comprising a controller (112) to control operation of the illumination device (110) for emitting the radiation.

10. The gemstone verification system (100) as claimed in claim 8, wherein the gemstone holder (106) comprises a first transparent glass and a second transparent glass aligned parallel to each other to direct radiation onto the gemstone (108), wherein the first transparent glass is fixed and the second transparent glass is movable along an axis.

11. The gemstone verification system (100) as claimed in claim 8, wherein the illumination device (110) is a laser source.

12. The gemstone verification system (100) as claimed in claim 8, wherein the screen (116) comprises
at least one fixed drum paper; and
at least one semi-transparent glass.

13. The gemstone verification system (100) as claimed in claim 8, wherein the computer system (118) comprises a bar code generator to generate a barcode based on the identification information, wherein the bar code is indicative of at least one of a dotted pattern, a color, clarity, a weight measurement, and a cut grade of the gemstone (108).

14. The gemstone verification system (100) as claimed in claim 8, wherein the computing system (104) further comprises a comparing module (218) to compare the identification information with the stored identification information to determine a match.

15. An optoelectronic assembly (102) comprising:
an illumination device (110) to emit a radiation incident on a gemstone (108);
a gemstone holder (106) to hold the gemstone (108) such that the gemstone (108):
receives the radiation emitted from the illumination device (110); and
refracts the radiation to generate a unique image pattern;
a screen (116) to form the unique image pattern corresponding to the gemstone (108); and
an image capturing device (118) to capture the unique image pattern formed on the screen (116), wherein the unique image pattern uniquely corresponds to the gemstone (108) and is associated with an identification information of the gemstone (108) for verifying the authenticity of the gemstone (108).

16. The optoelectronic assembly (102) as claimed in claim 15 further comprising an optical device (114) to
receive the radiation from the illumination device (110); and
spread the radiation into a plurality of radiations based on refraction of the radiation, wherein the plurality of radiations are directed towards the gemstone (108).

17. The optoelectronic assembly (102) as claimed in claim 15, wherein the optoelectronic assembly (102) is coupled to a computing system (104) to verify authenticity of the gemstone (108).
